(19) United States
(12) Patent Application Publication
(10) Pub. No.: US 2013/0226715 A1
(43) Pub. Date: Aug. 29, 2013

(54) APPARATUS AND METHOD FOR CONTROLLING NAVIGATION TO AN ADVERTISEMENT

(71) Applicant: Pantech Co., Ltd., (US)

(72) Inventors: Woo Jin LEE, Seoul (KR); Cho Long KIM, Seoul (KR)

(73) Assignee: Pantech Co., Ltd., Seoul (KR)

(21) Appl. No.: 13/705,902

(22) Filed: Dec. 5, 2012

(30) Foreign Application Priority Data
Feb. 29, 2012 (KR) 10-2012-0021493

(51) Int. Cl. G06Q 30/02

(52) U.S. Cl. CPC G06Q 30/0277
USPC 705/14.73

(57) ABSTRACT

An advertisement controlling apparatus includes a display unit to display a content of a program on a display area; a touch input unit to detect a first input on the display area; a determining unit to determine whether the display area comprises an advertisement area, and to determine whether a position of the first input corresponds to the advertisement area; and a processing unit to invalidate a command associated with the first input if the position of the first input corresponds to the advertisement area. An advertisement controlling method including determining, using the processor, whether a display area comprises an advertisement area based on a content for displaying on the display area; deactivating the advertisement area if the display area is determined to comprise the advertisement area; and invalidating a command associated with an input received in the display area if the input is associated with the deactivated advertisement area.

### CROSS-REFERENCE TO RELATED APPLICATION

This application claims priority from and the benefit of Korean Patent Application No. 10-2012-0021493, filed on Feb. 29, 2012, the entire disclosure of which is hereby incorporated by reference for all purposes as if fully set forth herein.

### BACKGROUND

1. FIELD

Exemplary embodiments of the present invention relate to a technology of controlling a command associated with an input on an advertisement area included in a display area.

2. Discussion of the Background

A terminal may support data communication by executing a web browser or an application. More specifically, the terminal may receive content from a server corresponding to an executed program and display the received content on a display area. If a touch is inputted on the display area, the terminal may navigate to a corresponding page by executing a command associated with the touch.

Here, if an unintended touch is inputted in an advertisement area located within the display area, the terminal may navigate to an advertisement page by executing a corresponding command associated with the touch. Accordingly, the inconvenience of navigating to the unintended page and incurring cost with respect to packet reception according to the page navigation may occur.

A method for storing, in an internal database of a terminal, a list of advertisement sites identified to be blocked has been introduced to address unintended navigation to advertisement pages. This method may limit navigation to a corresponding advertisement page by limiting a connection to a page of an advertiser in association with a received touch when a uniform resource locator (URL) of the advertisement page is detected from the list of advertisement sites.

However, since not every advertisement site may be verified, an advertisement blocking method using an advertisement site list may not be effective.

Accordingly, a technology that may more efficiently solve the inconvenience of navigating to an undesired advertisement page when performing data communication may be sought.

### SUMMARY

Exemplary embodiments of the present invention provide an apparatus and method for controlling a command associated with a touch inputted on an advertisement area included in a display area.

Additional features of the invention will be set forth in the description which follows, and in part will be apparent from the description, or may be learned by practice of the invention.

Exemplary embodiments of the present invention provide an advertisement controlling method using a processor including displaying a content on a display area; determining, using the processor, whether the display area comprises an advertisement; receiving a first input on the display area; determining whether a position of the first input corresponds to the advertisement area; and invalidating a command associated with the first input if the position of the first input corresponds to the advertisement area.

Exemplary embodiments of the present invention provide an advertisement controlling apparatus including a display unit to display a content of a program on a display area; a touch input unit to detect a first input on the display area; a determining unit to determine whether the display area comprises an advertisement area, and to determine whether a position of the first input corresponds to the advertisement area; and a processing unit to invalidate a command associated with the first input if the position of the first input corresponds to the advertisement area.

Exemplary embodiments of the present invention provide an advertisement controlling method using a processor including determining, using the processor, whether a display area comprises an advertisement area based on a content for displaying on the display area; deactivating the advertisement area if the display area is determined to comprise the advertisement area; and invalidating a command associated with an input received in the display area if the input is associated with the deactivated advertisement area.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a configuration of an advertisement controlling apparatus according to an exemplary embodiment of the present invention.

FIG. 2A and FIG. 2B are diagrams illustrating a syntax for verifying whether an advertisement area is included in a display area according to an exemplary embodiment of the present invention.

FIG. 3 illustrates an operation of an advertisement controlling apparatus according to an exemplary embodiment of the present invention.

FIG. 4 illustrates an operation of an advertisement controlling apparatus according to an exemplary embodiment of the present invention.

FIG. 5 is a flowchart illustrating an advertisement controlling method according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, an apparatus and method for controlling an advertisement according to exemplary embodiments of the present invention will be described with reference to the accompanying drawings. The advertisement controlling apparatus may be applicable to, for example, a mobile terminal, but is not limited thereto. Here, the advertisement controlling apparatus may include a display unit to display content of a program in response to a program execution request; a touch input unit to detect an input touch, a determining unit to determine an advertisement display area to display an advertisement on the display unit, and a processing unit to invalidate the input touch if a position of the input touch corresponds to the advertisement display area.

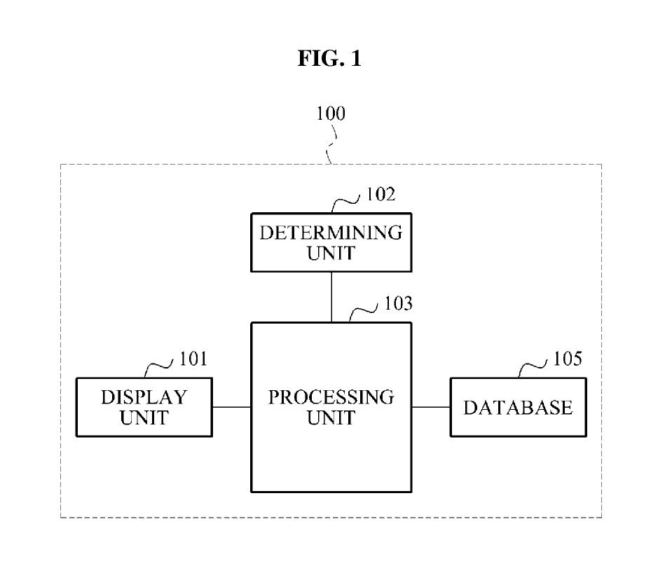

FIG. 1 is a block diagram illustrating a configuration of an advertisement controlling apparatus 100 according to an exemplary embodiment of the present invention.

Referring to FIG. 1, the advertisement controlling apparatus 100 may include a display unit 101, a determining unit 102, a processing unit 103, and a database 105.

In response to a request for executing a program, for example, a web browser, an application, or the like, the display unit 101 may display, on a display area or the entire screen area, content of a program that may be received from a server or an external source and may receive an input (e.g., a touch) on the display area. The request for executing a program may hereinafter be referred to as a program execution request. Further, the input received on the display area may be, without limitation, in a form of a touch, a mouse click, a key stroke, an input by a stylus, or other electronic writing utensil. For convenience of disclosure, the input may be described as being a touch or a touch input, but is not limited thereto.

If an advertisement area or an advertisement display area is included in the display area, the display unit 101 may display the advertisement area to be distinguishable from the display area according to control of the processing unit 103. More specifically, the display area, which may include a portion of a screen or the entire screen of the display unit 101, may be used to display the content. The advertisement area may overlap a portion of the display area to display an advertisement, and include a link to a corresponding advertisement page. In an example, the advertisement area may be distinguishable from the display area by being allocated to a reference area of the display area, having an outline around the advertisement area, having a reference marker or color included in the advertisement area, or the like.

The determining unit 102 may determine whether the advertisement area is included in the display area.

If a set link keyword is included in parsed content as a result of parsing of the content, the determining unit 102 may determine that the advertisement area is included or located in the display area where the content may be displayed. For example, if a program is a web browser, and if a uniform resource locator (URL) associated with an image, an animation, or the like is included as a set link keyword in the content received from a corresponding server, the determining unit 102 may determine that the advertisement area is included in the display area where the content may be displayed. Also, if the set link keyword, for example, a URL included in the content, is verified as an advertisement keyword, for example, advertisement site URL from an advertisement search server, or is retrieved from an advertisement site list within the database 105, the determining unit 102 may determine that the advertisement area is included in the display area where the content may be displayed.

Prior to transferring a signal corresponding to the inputted touch detected by the display unit 101 or a touch signal to a touch event processing unit (not shown), the processing unit 103 may verify whether the touch is associated with the advertisement area, which may be located within the display area. More specifically, the processing unit 103 may generate the touch signal to validate or invalidate a command associated with the touch based on the verification result of whether the touch is associated with the advertisement area. In an example, the command associated with the touch (i.e., a touch command) may be a command that may be executed in response to the inputted touch. Further, the processing unit 103 may provide the generated touch signal to the touch event processing unit. Accordingly, the processing unit 103 may control the validity of the touch command by generating the touch signal to validate or invalidate the touch command generated in response to the touch.

For example, the processing unit 103 may deactivate the advertisement area if the advertisement area is determined to be included in the display area, and may invalidate the command associated with the touch if the inputted touch is associated with the deactivated advertisement area. More specifically, if the advertisement area is determined to be included or located in the display area, the processing unit 103 may provide an environment capable of navigating to an advertisement page by providing the advertisement area, which may be activated under reference conditions. Further, the processing unit 103 may deactivate the advertisement area when the display area is determined to include the advertisement area. Accordingly, if a touch on the advertisement area is inputted due to an erroneous operation, the processing unit 103 may invalidate the touch command associated with the touch to limit or stop navigation to an advertisement page associated with the advertisement area. Accordingly, it may be possible to reduce the likelihood of unintentionally navigating to an advertiser's page and may save cost with respect to packet reception associated with the unintended page navigation.

Further, the processing unit 103 may deactivate the advertisement area in response to a determination that the advertisement area is included in the display area so that no signal or command may be generated if the touch is inputted in the deactivated area. Alternatively, the processing unit 103 may deactivate the advertisement area in response to a determination that the location of the inputted touch corresponds to the advertisement area included in the display area. In an example, the command may be generated to deactivate the advertisement area in response to the inputted touch.

In addition, the processing unit 103 may invalidate the touch command associated with the touch independent of deactivation of the advertisement area. More specifically, the processing unit 103 may determine that the location of the touch corresponds to the touch and generate the touch signal to validate or invalidate the command generated in response to the inputted touch.

Here, the processing unit 103 may verify or determine, as the advertisement area, an area located in the display area that matches or corresponds to the link keyword, and may invalidate the touch command associated with the touch if coordinates of the input touch corresponds to the advertisement area.

Also, for example, if the program is an application, the processing unit 103 may verify or determine, as the advertisement area, an area of a reference position in the display area, for example, a reference upper end area or a reference lower end area of the display area. More specifically, the advertisement area may be designated to a reference area or location within the display area. Further, multiple advertisement area may be designated, in which each advertisement area may correspond to a specific advertisement.

The processing unit 103 may invalidate the touch command associated with the touch if coordinates of the touch correspond to the advertisement area. In an example, the processing unit 103 may verify an attribute of the content, identify a provider associated with the content, and verify or determine, as the advertisement area, an area of the display area allocated to display an advertisement that may be linked to an advertisement page and associated with the identified provider. In an example, the provider of the content may allocate the advertisement area to an advertisement of the advertiser or sell the respective advertisement area to a different advertiser. For example, if a provider who has produced the content is a first provider, the processing unit 103 may verify or determine an upper end area of the display area as the allocated advertisement area for the first provider. If a provider who has produced the content is determined to be a second provider, the processing unit 103 may verify or determine a lower end area of the display area as the allocated advertisement area for the second provider.

The processing unit 103 may inform that the advertisement area is in a deactivated state by controlling the display unit 101 to display the advertisement area to be distinguishable from the display area. Here, the processing unit 103 may control the display unit 101 to display the advertisement area through at least one of anti-aliasing, alpha-blending, or shading processing.

Also, in response to an advertisement display request, the processing unit 103 may control the display unit 101 to navigate to an advertisement page or to remove the advertisement area.

For example, if a second touch or a retouch on the advertisement area is inputted within a reference period of time by the display unit 101 after a first touch is inputted, the processing unit 103 may validate a touch command associated with the retouch and control the display unit 101 to navigate to an advertisement page corresponding to the advertisement area. More specifically, if the retouch on the advertisement area is inputted, the processing unit 103 may recognize the retouch as an input to obtain the advertisement, and not as an erroneously inputted touch. Accordingly, the processing unit 103 may control the display unit 101 to navigate to the advertisement page according to the retouch. Here, the processing unit 103 may indicate a period of time in which a retouch having a valid touch command can be inputted by displaying a focus mark on the advertisement area or by processing a block of the advertisement area to be flickered but are not limited thereto.

Alternatively, the advertisement may be selected in response to an executed operation on a mobile terminal (e.g., pressing of a menu button), or in response to a confirmation message that may be provided in response to the initially inputted touch. In addition, the advertisement area, which may be deactivated in response to a determination that the advertisement area is included in the display area, may be reactivated in response to an executed operation in the mobile terminal or a confirmation message. Upon reactivation, the mobile terminal may navigate to a corresponding advertisement page in response to an inputted touch in the advertisement area.

Further, in an example, if a flicking operation or other comparable operation is inputted on the display area of the display unit 101, the processing unit 103 may control the display unit 101 to remove or hide the advertisement area from view by adjusting the display area. Here, the flicking operation may refer to touching and dragging a reference coordinate point in a reference direction. More specifically, if flicking operation on the advertisement area is inputted, the processing unit 103 may remove the advertisement area from the display area and extend content corresponding to the display area, which may now exclude the advertisement area, to display the content. Although flicking operation is described as being used to remove or hide the advertisement area, aspects of the present invention are not limited thereto. The advertisement area may be removed or hidden in response to at least one of a touching the advertisement area for a reference period of time, execution of a menu key operation, providing multiple touch are inputted in succession, and the like.

The processing unit 103 may receive a setting command about an advertisement deactivation processing option and may store the received setting command in the database 105. The processing unit 103 may be configured to invalidate a touch command on the advertisement area if the advertisement deactivation processing option is set to be “on”.

The database 105 may store a position of an advertisement area for one or more advertisers or advertisement site lists. Also, the database 105 may further store a setting command about an advertisement deactivation processing option.

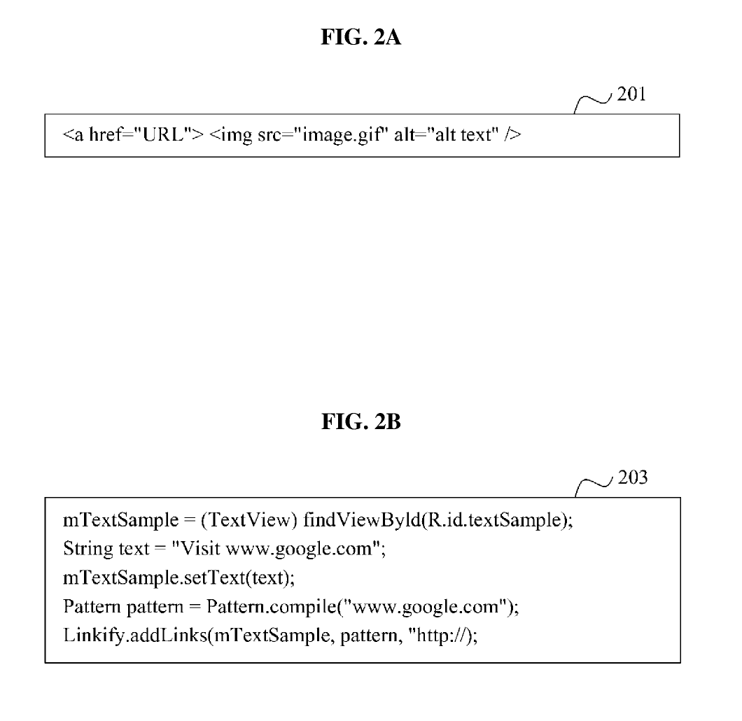

FIG. 2A and FIG. 2B are diagrams illustrating a syntax verifying whether an advertisement area is included in a display area according to an exemplary embodiment of the present invention.

Referring to FIG. 2A and FIG. 2B, in response to a program execution request, the advertisement controlling apparatus may display, on a display area, content of a program that may be received from a server or an external source. Further, the advertisement controlling apparatus may receive a touch on the display area. If an advertisement area is included in the display area, the advertisement controlling apparatus may deactivate the advertisement area. If the touch is associated with the deactivated advertisement area, the advertisement controlling apparatus may invalidate a touch command associated with the touch.

If a set link keyword is included in a parsed content as a result of parsing the content, the advertisement controlling apparatus may determine that the advertisement area is included in the display area where the content is displayed. For example, in response to a request for executing a web browser, the advertisement controlling apparatus may receive content from a corresponding server. If a URL 201 associated with an image, an animation, or the like is included as a set link keyword in the received content, the advertisement controlling apparatus may determine that the advertisement area is included in the display area where the content may be displayed.

Also, if a link keyword, for example, a URL included in the parsed content is verified as an advertisement keyword, for example, an advertisement site URL from an advertisement search server as the result of parsing the content, the advertisement controlling apparatus may determine that the advertisement area may be included in the display area. For example, in response to a request for executing an application, the advertisement controlling apparatus may receive content from a corresponding server, detect a URL 203 associated with a hyperlink using, for example, TextView from the received content, and may transmit a request for verifying an advertisement keyword of the detected URL to an advertisement search server. If the advertisement controlling apparatus receives an advertisement keyword authentication response in response to the request, the advertisement controlling apparatus may determine that the advertisement area is included in the display area.

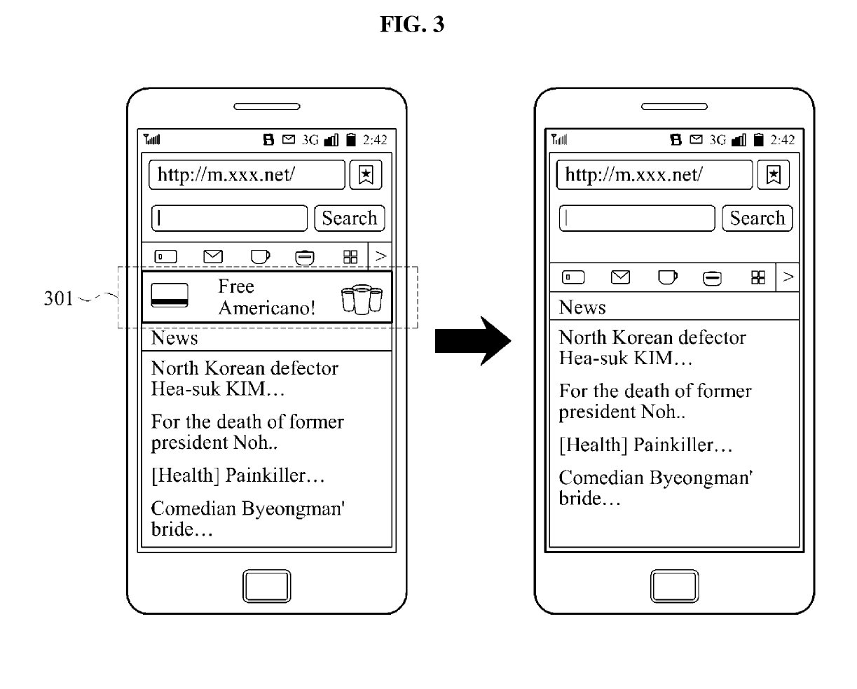

FIG. 3 illustrates an operation of an advertisement controlling apparatus according to an exemplary embodiment of the present invention.

Referring to FIG. 3, in response to a request for executing a web browser, the advertisement controlling apparatus may display, on a display area, content that may be received from a server or an external source. Here, if an advertisement area is included in the display area, the advertisement controlling apparatus may display the advertisement area to be distinguishable from the display area.

The advertisement controlling apparatus may deactivate the advertisement area. If a touch on the display area is associated with the deactivated advertisement area, the advertisement controlling apparatus may invalidate a touch command associated with the touch. For example, the advertisement controlling apparatus may invalidate an advertisement area 301 associated with a coffee advertisement. If a touch on a display area is associated with the advertisement area 301 associated with a coffee advertisement, the advertisement controlling apparatus may invalidate a touch command associated with the touch and maintain the display area without navigating to a coffee advertisement page.

In an example, if a flicking operation or the like is performed on the advertisement area 301, the advertisement controlling apparatus may remove the advertisement area 301 by adjusting the display area. For example, if flicking operation is inputted in a right direction with respect to the advertisement area 301 associated with the coffee advertisement, the advertisement controlling apparatus may remove the advertisement area 301 and extend content corresponding to the display area to display the content.

Further, if a retouch on the advertisement area 301 is inputted within a reference period of time after the touch is inputted, the advertisement controlling apparatus may validate a touch command associated with the retouch and navigate to an advertisement page corresponding to the advertisement area 301. Here, for example, the advertisement controlling apparatus may display a focus mark on the advertisement area 301 for three seconds, or may display a period of time in which a retouch having a valid touch command can be inputted by processing a block of the advertisement area 301 to be flickered. If the retouch on the advertisement area 301 is inputted during the reference period, the advertisement controlling apparatus may execute a touch command associated with the retouch. That is, if a retouch on the advertisement area 301 associated with the coffee advertisement is inputted while maintaining the focus mark or flicker of the block of the advertisement area 301, the advertisement controlling apparatus may navigate to the advertisement page associated with the coffee advertisement and provide a coffee advertisement.

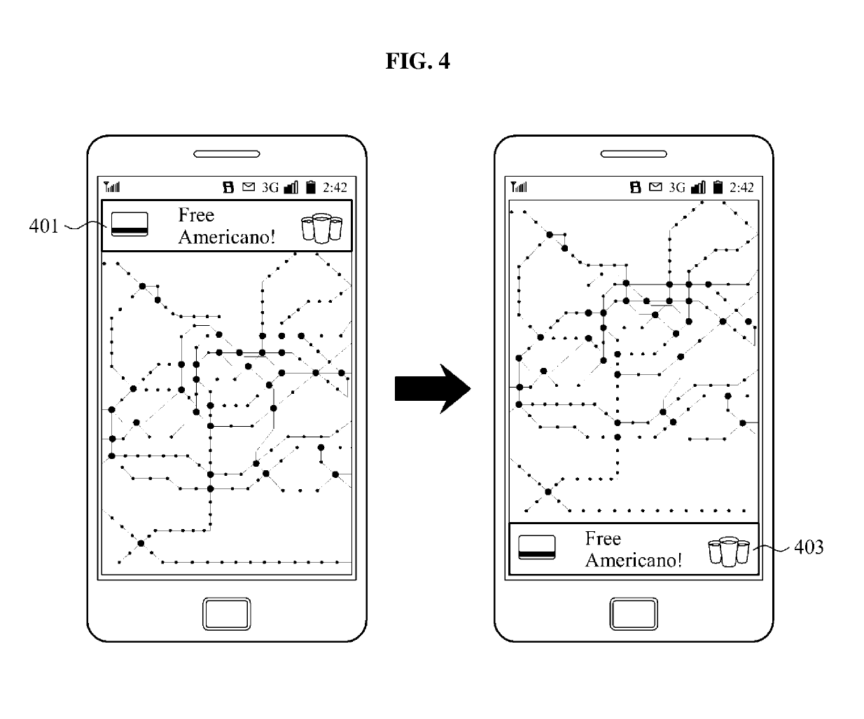

FIG. 4 illustrates an operation of an advertisement controlling apparatus according to an exemplary embodiment of the present invention.

Referring to FIG. 4, in response to a program execution request, the advertisement controlling apparatus may display, on a display area, content of a program that may be received from a server. Here, if an advertisement area is included in the display area, the advertisement controlling apparatus may display the advertisement area to be distinguishable from the display area. The advertisement area may be excluded by processing the advertisement area through at least one of anti-aliasing, alpha-blending, or shading processing.

Here, for example, if the advertisement controlling apparatus receives content from a server in response to a request for executing a web browser, the advertisement controlling apparatus may extract a link keyword by parsing the received content. If the extracted link keyword is a set link keyword, for example, a URL associated with an image, animation, or the like, the advertisement controlling apparatus may verify, as the advertisement area, a layout area that matches or corresponds to the link keyword in the display area.

Also, for example, if the advertisement controlling apparatus receives content from a server in response to a request for executing an application, the advertisement controlling apparatus may verify, as the advertisement area, an area of a reference position in the display area, for example, an upper end area or a lower end area of the display area. Here, the advertisement controlling apparatus may verify an attribute of content, may identify a provider who produced the content, and may verify, as the advertisement area, an area of a position corresponding to the identified provider in the display area.

For example, if the advertisement controlling apparatus receives content from a server in response to an application execution request associated with subway, the advertisement controlling apparatus may verify an attribute of the content and may identify a provider who has produced the content. If the identified provider is a first provider, the advertisement controlling apparatus may verify a reference upper end area 401 as the advertisement area. Also, if the identified provider is a second provider, the advertisement controlling apparatus may verify a reference lower end area 403 as the advertisement area.

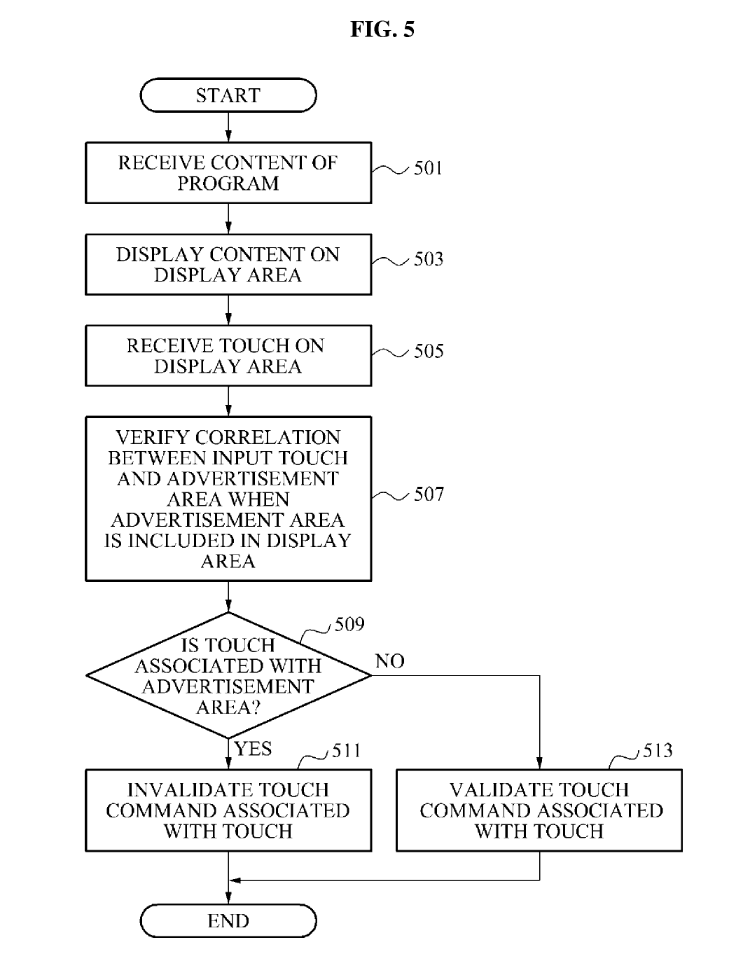

FIG. 5 is a flowchart illustrating an advertisement controlling method according to an exemplary embodiment of the present invention.

In operation 501, an advertisement controlling apparatus may receive content of a program from a server in response to a program execution request. Here, in response to execution of a web browser or an application, the advertisement controlling apparatus may receive the content from the server corresponding to the program.

In operation 503, the advertisement controlling apparatus may display the received content on a display area.

If the advertisement area is included in the display area where the content is displayed, the advertisement controlling apparatus may display the advertisement area to be distinguishable from the display area. More specifically, the advertisement controlling apparatus may display the advertisement area to be distinguishable from the display area by processing the advertisement area through at least one of anti-aliasing, alpha-blending, or shading processing.

If a set link keyword is included in parsed content as a result of parsing the content, the advertisement controlling apparatus may determine that the advertisement area may be included in the display area where the content is displayed. For example, if the program is a web browser, and if a URL associated with an image, animation, or the like is included as a set link keyword in the content received from the corresponding server, the advertisement controlling apparatus may determine that the advertisement area is included in the display area where the content is displayed. Also, if the link keyword, for example, a URL included in the content, is verified as an advertisement keyword, for example, an advertisement site URL from an advertisement search server, or if the link key word is retrieved from an advertisement site list within a database, the advertisement controlling apparatus may determine that the advertisement area is included in the display area where the content is displayed.

Here, the advertisement controlling apparatus may verify, as the advertisement area, a layout area that corresponds to the link keyword in the display area, or may verify, as the advertisement area, an area of a reference position in the display area, for example, a reference upper end area or a reference lower end area of the display area. Here, if the advertisement controlling apparatus verifies the area of the reference position as the advertisement area, the advertisement controlling apparatus may identify a provider associated with the content and may obtain, from the database, an area corresponding to the identified provider in the display area. Accordingly, the advertisement controlling apparatus may verify the obtained area as the advertisement area.

In operation 505, the advertisement controlling apparatus may receive a touch on the display area.

In operation 507, if the advertisement area is included in the display area, the advertisement controlling apparatus may deactivate the advertisement area and may verify whether the input touch is associated with the deactivated advertisement area. Here, if coordinates of the inputted touch on the display area is included in the advertisement area, the advertisement controlling apparatus may verify that the touch is associated with the advertisement area.

If the touch is associated with the advertisement area in operation 509, the advertisement controlling apparatus may invalidate a touch command associated with the touch in operation 511.

On the contrary, if the touch is not associated with the advertisement area in operation 509, the advertisement controlling apparatus may validate a touch command associated with the touch in operation 513.

If a retouch on the advertisement area is inputted within a reference period of time after the inputted touch, the advertisement controlling apparatus may validate a touch command associated with the retouch and may navigate to an advertisement page corresponding to the advertisement area. Here, the advertisement controlling apparatus may indicate a period of time in which a retouch having a valid touch command can be inputted by displaying a focus mark on the advertisement area or by processing a block of the advertisement area to be flickered.

Also, if a flicking operation on the display area is inputted, the advertisement controlling apparatus may remove the advertisement area by adjusting the display area. Here, the flicking operation may indicate touching and dragging a reference coordinate point in a reference direction. That is, if the flicking operation on the advertisement area is inputted, the advertisement controlling apparatus may remove the advertisement area and extend content corresponding to the display area to display the content.

According to exemplary embodiments of the present invention, if a touch on a display area where content may be displayed is associated with an advertisement area that is included in the display area, a touch command associated with the touch may be invalidated. Accordingly, it may be possible to reduce the inconvenience of navigating to an undesired page. Further, it may be possible to save costs associated with packet reception according to the page navigation by limiting navigation to an unintended advertisement page.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media, such as CD ROM disks and DVD; magneto-optical media, such as floptical disks; and hardware devices that are specially configured to store and perform program instructions, such as read-only memory (ROM), random access memory (RAM), flash memory, and the like. Examples of program instructions to include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An advertisement controlling method using a processor, comprising:
displaying a content on a display area;
determining, whether the display area comprises an advertisement;
receiving a first input on the display area;
determining whether a position of the first input corresponds to the advertisement area; and
invalidating a command associated with the first input if the position of the first input corresponds to the advertisement area.

2. The advertisement controlling method of claim 1, further comprising deactivating the advertisement area if the display area is determined to comprise the advertisement area.

3. The advertisement controlling method of claim 1, wherein the display area is determined to comprise the advertisement area based on the content.

4. The advertisement controlling method of claim 3, wherein the display area is determined to comprise the advertisement area if the content comprises a link keyword, the link keyword comprising a uniform resource locator (URL) associated with at least one of an image and an animation.

5. The advertisement controlling method of claim 1, further comprising displaying the determined advertisement area on the display area using at least one of anti-aliasing, alpha-blending, and shading processing.

6. The advertisement controlling method of claim 1, further comprising receiving a second input on the advertisement area within a reference period of time after receiving the first input, wherein the second input on the advertisement area generates a command to navigate to an advertisement page corresponding to the advertisement area.

7. The advertisement controlling method of claim 1, wherein a location of the advertisement area on the display area corresponds to a specific advertiser.

8. The advertisement controlling method of claim 6, further comprising displaying an indicator for indicating the reference period of time in which the second input is allowed to be received on the advertisement area.

9. The advertisement controlling method of claim 1, further comprising performing an operation on the advertisement area to remove the advertisement area from the display area.

10. An advertisement controlling apparatus, comprising:
a display unit to display a content of a program on a display area;
a touch input unit to detect a first input on the display area;
a determining unit to determine whether the display area comprises an advertisement area, and to determine whether a position of the first input corresponds to the advertisement area; and
a processing unit to invalidate a command associated with the first input if the position of the first input corresponds to the advertisement area.

11. The advertisement controlling apparatus of claim 10, wherein the processing unit deactivates the advertisement area if the display area is determined to comprise the advertisement area.

12. The advertisement controlling apparatus of claim 10, wherein the display area is determined to comprise the advertisement area based on the content.

13. The advertisement controlling apparatus of claim 12, wherein the display area is determined to comprise the advertisement area if the content comprises a link keyword, the link keyword comprises a uniform resource locator (URL) associated with at least one of an image and an animation.

14. The advertisement controlling apparatus of claim 10, further comprising a database unit to store a position of the advertisement area associated with an advertiser.

15. The advertisement controlling apparatus of claim 10, wherein the touch input unit receives a second input on the advertisement area within a reference period of time after receiving the first input, wherein the second input on the advertisement area generates a command to navigate to an advertisement page corresponding to the advertisement area.

16. The advertisement controlling apparatus of claim 10, further comprising a database unit to store an allocated location of the advertisement area on the display area associated with a specific advertiser.

17. The advertisement controlling apparatus of claim 15, wherein the display unit displays an indicator to indicate the reference period of time in which the second input is allowed to be received on the advertisement area.

18. The advertisement controlling apparatus of claim 15, wherein the touch input receives a flicking operation on the advertisement area to remove the advertisement area from view.

19. The advertisement controlling apparatus of claim 15, wherein the processing unit controls the display unit to display the determined advertisement area on the display area using at least one of anti-aliasing, alpha-blending, and shading processing.

20. An advertisement controlling method using a processor, comprising:
determining, whether a display area comprises an advertisement area based on a content for displaying on the display area;
deactivating the advertisement area if the display area is determined to comprise the advertisement area; and
invalidating a command associated with an input received in the display area if the input is associated with the deactivated advertisement area.
